(19) United States
(12) Patent Application Publication
(10) Pub. No.: US 2026/0260384 A1
(43) Pub. Date: Sep. 3, 2026

(54) MULTIPLE-REFERENCE PREDICTIONS FOR RENDERING PRIMITIVES CODING

(71) Applicant: Nokia Technologies Oy, Espoo (FI)

(72) Inventors: Patrice RONDAO ALFACE, Antwerp (BE); Daniele MARI, Antwerp (BE); Lukasz KONDRAD, Munich (DE)

(21) Appl. No.: 19/552,371

(22) Filed: Feb. 27, 2026

Related U.S. Application Data
(60) Provisional application No. 63/765,984, filed on Mar. 3, 2025.

(51) Int. Cl. G06T 9/00; G06V 10/60

(52) U.S. Cl. CPC G06T 9/001; G06V 10/60

(57) ABSTRACT

In accordance with one aspect, an example apparatus is provided comprising: at least one processor; and at least one memory storing instructions that, when executed with the at least one processor, cause the apparatus to perform: identifying, with a pre-processing module, positional information and one or more attributes of a radiance field representation; selecting, with a reference search module, one or more reference primitives based at least in part on the positional information and the one or more attributes of the radiance field representation; and encoding one or more positions and one or more attributes of the selected one or more reference primitives. Decoding of the one or more positions and attributes to reconstruct content with reconstruction metadata received via a bitstream is provided.

### TECHNICAL FIELD

The example and non-limiting embodiments relate generally to volumetric frame rendering and, more particularly, to predicting positional data and attributes for rendering a primitive in a N-dimensional space based on multiple reference primitives.

### BRIEF DESCRIPTION OF PRIOR DEVELOPMENTS

There are many ways to capture and represent a volumetric scene. The format used to capture and represent a volumetric scene depends on the processing to be performed on it, and the target application using it.

A volumetric frame can be represented as a point cloud. A point cloud is a set of unstructured points in 3D space, where each point is characterized by its position in a 3D coordinate system (e.g. Euclidean), and some corresponding attributes (e.g. color information provided as RGBA value, or normal vectors)

A volumetric frame can be represented as images, with or without depth, captured from multiple viewpoints in 3D space. In other words, the volumetric frame can be represented by one or more view frames where a view is a projection of a volumetric scene on to a plane (the camera plane) using a real or virtual camera with known/computed extrinsic and intrinsic values. Each view may be represented by a number of components (e.g. geometry, color, transparency, and occupancy picture), which may be part of the geometry picture or represented separately.

A volumetric frame can be represented as a mesh. Mesh is a collection of points, called vertices, and connectivity information between vertices, called edges. Vertices along with edges form faces. The combination of vertices, edges and faces can uniquely approximate shapes of objects.

A volumetric frame can be represented as a radiance field, i.e., a representation of rays of light in the scene (sometimes referred to as the plenoptic function or light fields etc.), that can be captured for example by multiple viewpoints such as provided by a number of light field cameras or a number of omnidirectional or plenoptic cameras. Several radiance field representations are described in the following.

A volumetric frame can be represented as an implicit and learned neural radiance field such as the Neural Radiance Field (NeRF) representation for example. A NeRF is a representation of a 3D scene that is parameterized by a deep neural network (DNN). The network predicts a volume density and view-dependent emitted radiance given the spatial location (x, y, z) and viewing direction, e.g., in Euler angles (θ, φ, ψ) of the camera. Volume rendering techniques can produce an image by sampling points along rays intercepted by the camera projection model.

A volumetric frame can be represented as a learned radiance field such as the Gaussian Splatting (a.k.a., 3DGS, 4DGS, Gaussian Splat) representation. This representation can be seen as a point cloud representation with additional attributes that model the geometry and appearance of the scene in the close neighborhood of a position (x, y, z). Rendering of radiance fields represented as Gaussian splats and other variants using modified versions of the attributes may be performed by simple and fast rasterization or more accurate volume rendering using ray tracing.

Depending on the capture, a volumetric frame can provide viewers the ability to navigate a scene with six degrees of freedom, i.e., both translational and rotational movement of their viewing pose (which includes yaw, pitch and roll). The data to be coded for a volumetric frame can also be significant, as a volumetric frame can contain large numbers of objects, and the positioning and movement of these objects in the scene can result in many dis-occluded regions. Furthermore, the interaction of light and materials in objects and surfaces in a volumetric frame can generate complex light fields that can produce texture variations for even a slight change of pose.

A sequence of volumetric frames is a volumetric video. Due to large amount of information, storage and transmission of a volumetric video requires compression.

### SUMMARY OF THE INVENTION

The following summary is merely intended to be an example. The summary is not intended to limit the scope of the claims.

In accordance with one aspect, an example apparatus is provided comprising: at least one processor; and at least one memory storing instructions that, when executed with the at least one processor, cause the apparatus to perform: identifying, with a pre-processing module, positional information and one or more attributes of a radiance field representation. Additionally, the apparatus may be caused to perform: selecting, with a reference search module, one or more reference primitives based at least in part on the positional information and the one or more attributes of the radiance field representation. Additionally, the apparatus may be caused to perform: encoding one or more positions and one or more attributes of the selected one or more reference primitives.

In accordance with one aspect, an example apparatus is provided comprising: at least one processor; and at least one memory storing instructions that, when executed with the at least one processor, cause the apparatus to perform: decoding one or more bitstreams to extract metadata information, positional information for a radiance field representation, and one or more attributes of the radiance field representation. Additionally, the apparatus may be caused to perform: reconstructing, based at least in part on the extracted metadata information, the radiance field representation for volumetric rendering using one or more reference primitives obtained from a plurality of reference primitives.

According to some aspects, there is provided the subject matter of the independent claims. Some further aspects are provided in subject matter of the dependent claims.

### BRIEF DESCRIPTION OF DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 illustrates an example point cloud (e.g., a Gaussian Splat) in accordance with example embodiments of the disclosure;

FIGS. 3A and 3B illustrate example spherical harmonics (FIG. 3A) and a visual comparison with DCT basis functions (FIG. 3B);

FIGS. 4A-4C illustrate example reference primitives for predicting positions or attributes of representation primitives in accordance with example embodiments of the disclosure;

FIG. 5 illustrates an example of multiple reference primitives for two consecutive volumetric frames in accordance with example embodiments of the disclosure;

FIG. 6 illustrates an example encoder flowchart in accordance with example embodiments of the disclosure;

FIG. 7 illustrates an example per packet encoder flowchart in accordance with example embodiments of the disclosure;

FIGS. 8A and 8B illustrate example flowcharts for prediction of an input signal, generation of a residual, reference buffer and reference index list in accordance with example embodiments of the disclosure;

FIG. 9 illustrates an example decoder flowchart in accordance with example embodiments of the disclosure;

FIG. 10 illustrates an example flowchart for decoding with reference mechanisms in accordance with example embodiments of the disclosure;

FIGS. 11 and 12 illustrate example flow diagrams in accordance with one or more example embodiments of the disclosure.

### DETAILED DESCRIPTION

The following abbreviations that may be found in the specification and/or the drawing figures are defined as follows:

| | ISO/IEC 23090-9 Geometry based |
|---|---|
| G-PCC | Point Cloud Compression |
| GS | Gaussian Splat |
| LOD | Level of Detail |
| LUT | Look Up Table |
| SEI | Supplemental Enhancement Information |

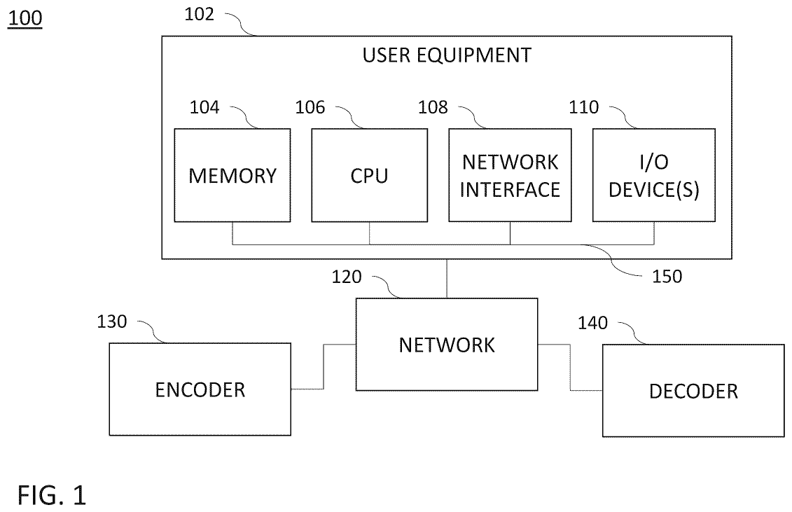

Turning to FIG. 1, this figure shows a block diagram 100 of one possible and non-limiting example in which the examples may be practiced. A user equipment (UE) 102, an encoder device 130, a decoder device 140, and a network 120 are illustrated. Examples of network equipment, network device, or a network entity might be understood to include, at least part of, a transmission reception point or a cell or a gNB or node for example. In the example of FIG. 1, the user equipment (UE) 102 may be in wireless communication with a wireless network 120. A UE may be a wireless device that can access the wireless network 100. The UE 102 includes one or more processors 106, one or more memories 104, one or more network interfaces 108, and one or more input/output device interfaces 110 interconnected through one or more buses 150. Each of the one or more network interfaces 108 may include a receiver, Rx, and a transmitter, Tx. The one or more buses 150 may be address, data, or control buses, and may include any interconnection mechanism, such as a series of lines on a motherboard or integrated circuit, fiber optics or other optical communication equipment, or the like. The one or more network interfaces 108 may be connected to one or more antennas.

The one or more memories 104 may include computer program code. The UE 102 may include one or more modules. The modules 140 may be implemented in hardware, such as being implemented as part of the one or more processors 106. The module may be implemented also as an integrated circuit or through other hardware such as a programmable gate array. In another example, the module may be implemented as computer program code and may be executed by the one or more processors 106. For instance, the one or more memories 104 and the computer program code may be configured to, with the one or more processors 106, cause the user equipment 102 to perform one or more of the operations as described herein. The UE 102 may communicate with other user equipment (e.g., additional instantiations of UE 102) via wired or wireless network 120. Encoder 130 or Decoder 140 may include some, all, or additional features described in conjunction with UE 102. For example, Encoder 130 or Decoder 140 may be example instantiations of UE 102. In some embodiments, a UE 102 may have encoding and decoding capabilities as described in the disclosed technology herein.

The network 120 may include a network element or elements that may include core network functionality, and which provides connectivity via a link or links with a further network, such as a telephone network and/or a data communications network (e.g., the Internet). Such core network functionality for 5G may include access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. These are merely exemplary functions that may be supported by the network element(s), and note that both 5G and LTE functions might be supported.

The network 120 may be a wireless network configured to implement network virtualization, which is the process of combining hardware and software network resources and network functionality into a single, software-based administrative entity, a virtual network.

Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors and memories, and also such virtualized entities create technical effects.

The computer readable memories 104 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 104 may be means for performing storage functions. The processors 106 may be of any type suitable to the local technical environment, and may include one or more of general purpose computers, special purpose computers, microprocessors, digital signal processors (DSPs) and processors based on a multi-core processor architecture, as non-limiting examples. The processors 106 may be means for performing functions, such as controlling the UE 102, encoder device 130, decoder device 140, and other functions as described herein.

In general, the various embodiments of the user equipment 102 may include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

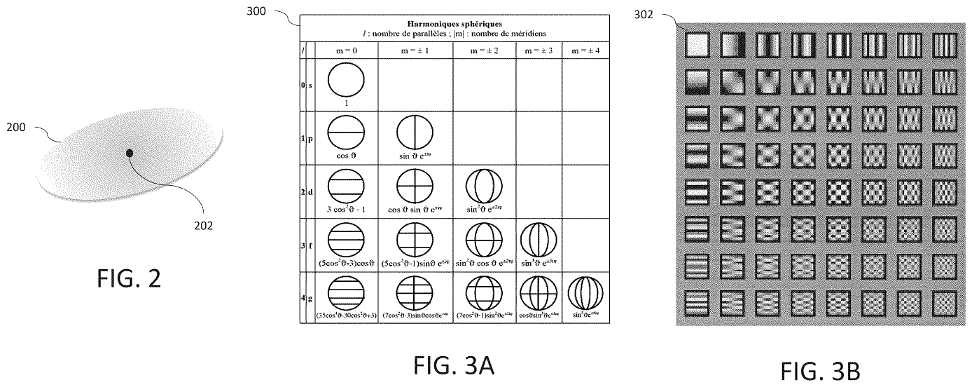

Gaussian splats may be seen as point clouds with additional attributes as illustrated in FIG. 2.
Attributes of the Gaussian Splats are:
   Position (x,y,z)
   Scale (sx,sy,sz); i.e., non-uniform scale factor of the Gaussian splat
   Rotation (rx,ry,rz) or (qx,qy,qz,qw); i.e., the rotation of the Gaussian splat with respect to world coordinates, the rotation is expressed by Euler angles or quaternions
Optionally, Normal (nx, ny, nz); i.e., the normal vector of the Gaussian splat
   Opacity (alpha), i.e., a factor that indicates the transparency of the Gaussian splat
   Color (r,g,b), i.e., the primary color of the Gaussian splat
Spherical harmonics (e.g. SH[0:48]), i.e., the reflectance of the Gaussian splat expressed in spherical harmonics

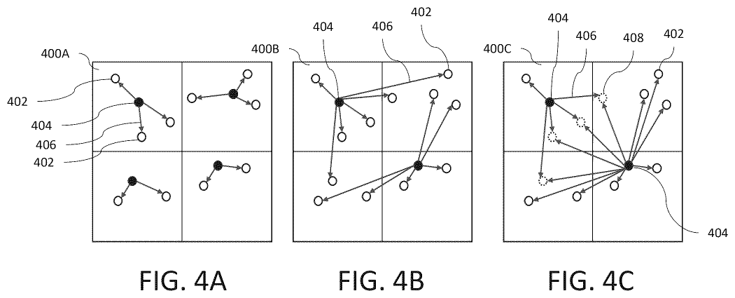

Sometimes color is represented by the DC component of spherical harmonics, and spherical harmonics contain 45 non-DC components. Spherical harmonics can be seen as DCT basis functions defined on the sphere (see FIG. 3).

The rendering function for a Gaussian splat is as follows:

$${g}_{i} ( p ) = α exp ( - \frac{1}{2} ( p - {μ}_{i} ) {\sum }_{i}^{- 1} ( p - {μ}_{i} ) )$$

Where Σ is the covariance matrix and is equal to:

$$\sum = {RSS}^{T} {R}^{T}$$

Where R is a 3×3 rotation matrix expressed with 4 quaternions and S is a diagonal scaling matrix with 3 parameters for scale.

FIG. 2 illustrates an example Gaussian Splat 200. The position information is the one of its center highlighted by a circle 202. The size and orientation of the shape of splat 200 may be determined by, for example, scale and rotation. The color, transparency and reflectivity may be defined by the spherical harmonics and opacity.

FIG. 3A illustrates example Spherical Harmonics 300. FIG. 3B illustrates a visual comparison with DCT basis functions in 302. Similarly to DCT that enables low to high frequency variations on the horizontal and vertical axis of an image, increasing order of spherical harmonics shows increasing frequency variations in vertical and horizontal directions on the sphere. The first component (m=0, 1=0), referred to as DC represents a constant value over the sphere, the second component (m=0, 1=1) enables a variation from south pole to north pole following cos(theta), the third component enables a variation from one side of the equator to the other side, etc. Multiplying the three color components RGB to these 15 basis functions on the sphere leads to 45 spherical harmonics components as illustrated in FIGS. 3A and 3B. Some approaches achieve a fast estimation of the Spherical harmonics transform and inverse transform by relying on the FFT.

Other variants of radiance fields representations may include:
Spherical point clouds, which are similar to Gaussian splats except that the shape is spherical, i.e., there is only one scale factor and there is no rotation attribute data and no falloff due to the gaussian probability distribution.
Ellipsoids, while sharing similar attributes with Gaussian splats, the rendering includes a cut-off at the ellipsoid scale-driven boundary and a constant opacity in the ellipsoid.
Billboards, where the attributes are common with Gaussian splats but the rendering equation is defined on a rectangle
2DGS or surfels, similar to Gaussian splats but where the smallest scale is set to zero and a normal is defined. These are typically defined on surfaces in the tangent space. The rendering equation is the same as for Gaussian splats
Gaussian splats with neural appearance attributes, where view dependent appearance is represented by latent variables. The rendering equation requires a MLP to decode the latent appearance

For purposes of this disclosure, “representative primitive” will refer to Gaussian Splats and their variants. Other terms may be used interchangeable, such as “rendering primitive” or “radiance field representation.”

The problem consists in coding rendering primitives such as Gaussian Splats for example by reducing the amount of correlation between primitives positions and attributes in both intra (in the same temporal frame) and inter cases (between different temporal frames). Positions may be coded efficiently using for example octree approaches depending on the density or sparsity of the rendering primitives in a given neighborhood. Attributes, however, could be very similar when they relate to the same material, e.g., an auditorium with seats may be represented by representation primitives with similar attributes up to lighting and shadow effects. Due to the nature of these effects, the best prediction of an attribute of a primitive may be obtained by a distant primitive, which will not be obtained with octree approaches that exploit local neighborhoods in a hierarchical manner. Moreover, most approaches only use one primitive as a prediction for positions and/or all its attributes, which may not be optimal when interpolation of attributes is required to produce lower-energy residuals.

In some embodiments of the disclosed technology, a multi-reference intra and/or inter prediction mode allowing to predict a position, an attribute or set of attributes from different and multiple references is described. Using different references for different attributes brings benefits as two representation primitives A and B may have similar color but different reflectivity for example, while a third representation primitive C may have a different color when comparing to the two first representation primitives A and B, but a similar reflectivity as one of these (A or B). Using multiple references for the same attribute enables to predict attribute effects such as blending and interpolation, which may greatly reduce the energy and bitrate of residuals. Multiple references require weights that can be set by default or be signaled to the decoder.

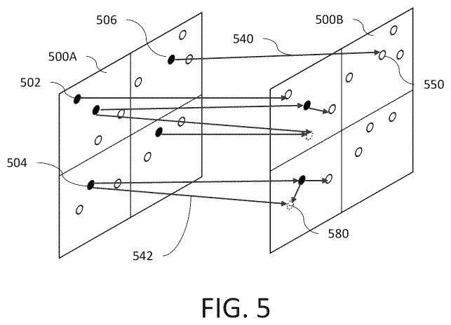

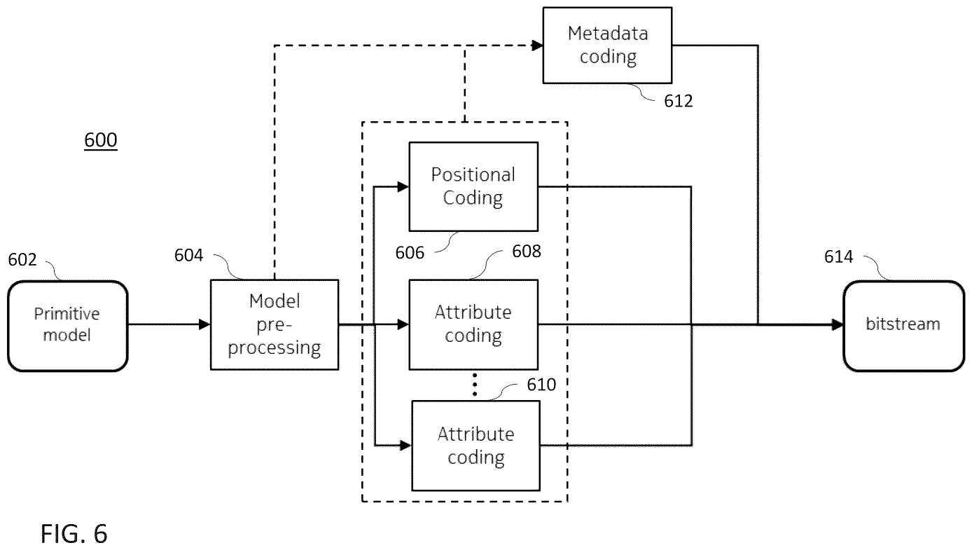

Similarly, with respect to the temporal aspect, the position of primitives in the current frame may be predicted by the position of one or more reference primitives from the past and/or from the current frame as well. Combining inter and intra prediction is useful for complex motion but also for attributes, that can be blended between a previous observation and a neighboring observation of primitives due to environment lighting changes etc. FIGS. 4A-4C and 5 illustrate these aspects further.

FIGS. 4A-4C illustrates references for predicting positions or attributes. Frame 400A shows reference primitives as black dots 404 in quadrants of a given scene representation. Arrows 406 show that white primitives 402 are predicted from the black reference primitives 404. Such prediction may be a displacement (distance represented by the arrow 406) for the positional information of the primitive, a copy of an attribute or of all attributes. 400B shows that the choice of the reference primitive may not lead to short arrows, rather the choice may be done so that the attribute prediction leads to the smallest error. 400C shows primitives with dashed contour and white fill 408 being predicted from two reference primitives 404 (fill in black), allowing attribute interpolation or blending. More than two references for a splat are possible as well.

FIG. 5 illustrates multiple references for two consecutive volumetric frames 500A and 500B. Primitives used as references 506 are illustrated in black, arrows 540 show the correspondence between predicted primitive 550 and its reference(s) 506. Dotted circles 580 represent primitives that are predicted by more than one reference. References used to predict a temporal frame can be all located in another temporal frame and/or in the same temporal frame, likewise part of the references may be located in other temporal frames than the other references.

As described herein, a representation/rendering primitive is a geometric object that can be used for rendering and it is characterized by a position in a N-dimensional space. A representation/rendering primitive may be further characterized by additional geometric attributes (e.g. the scales and the rotations for an ellipsoid or a gaussian, or the dimensions and rotation of a rectangle, cube, plane, hypercube, etc.) and possibly some additional attributes (e.g. color, representation learned through gradient descent or a neural network, semantic information, material information, etc.) that will be referred to as non-geometric or appearance attributes. One example of rendering primitive is a 3D Gaussian splat as illustrated by FIG. 2, 200.

### Encoder Embodiments

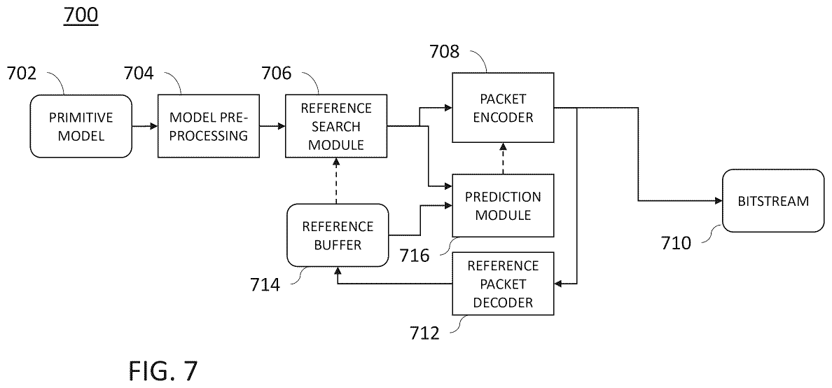

An example workflow 600 for an encoder is illustrated in FIG. 6. Input may be received at 602 as a primitive model. The primitive model may include representation primitives such as Gaussian splats. The primitives may be preprocessed 604 in the model pre-processing module. Pre-processing may include voxelization and quantization of the positions and attribute information contained in the primitive model. The data relative to the primitives such as the position and attributes may be sent to different and dedicated coding modules, such as the positional coding module 606, which may use a point cloud codec using octree-based coding techniques or projection-based coding techniques for example. Attribute coding modules 608 and 610 may use dedicated attribute codec approaches, such as relying first on decoded and reconstructed positional data to recolor the attributes, transform them and predict them using a nearest neighbor approach such as in G-PCC. In another embodiment, the attribute data may be coded using other codec approaches, being a neural approach, projections to video, vector quantization, or the like. The choices made in these coding modules and all information inferred in the preprocessing module may be coded using metadata coding module 612. The metadata module output stream contains all necessary signaling to reconstruct primitives after decoding the streams corresponding to the positional and attribute coding modules. The encoder produces a bitstream 614 that include all necessary metadata and data substreams that are obtained from the positional and attribute coding modules. Metadata may be coded and signaled along or inside the bitstream. Positional and attributes bitstreams may be multiplexed together in the single bitstream in a variety of ways.

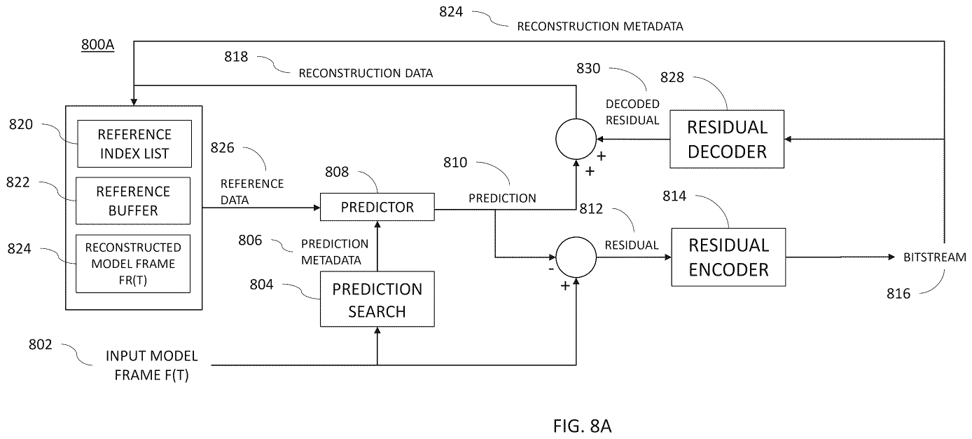

FIG. 7 illustrates an example per-packet encoder flowchart 700. FIG. 7 illustrates the encoder flowchart differently by highlighting the reference and prediction mechanisms. The encoder processes the input primitive model 702 via the model pre-processing module 704 as in FIG. 6. The Encoder then uses a reference search module 706 that selects primitives that are good candidates for prediction, as described herein. The Encoder then uses a packet encoder 708, which is an encoding module that can encode primitive positions, primitive attributes or primitive positions and attributes. The output of this packet encoder module is added to the bitstream 710. The output of the packet encoder is decoded by the reference packet decoder 712 that outputs reference primitives (their positions, attributes or all) and store them in a reference buffer 714. The encoder then processes the primitives that were not selected as references and optionally searches among these primitives if some of them could also serve as reference for other non-reference primitives in a hierarchical/sequential manner. Taking the simplest example of two levels hierarchy, in this case, all non-reference primitives are sent to the packet encoder, which now also uses the output of the prediction module 716 that ingests the reference buffer primitives from the reference packet. The output of the packet encoder is sent to the bitstream 710.

In more complex settings where more than two levels or packets are created, then intermediate packets of primitives are predicted from a lower level reference packet primitives. The reference packet decoder may then also include a reference buffer and a prediction module.

In some embodiments, in the bitstream, the reference primitives can be decoded independently, providing a coarse representation as an independent reference packet. Other primitives, for example in a two-levels setting, can be decoded if the reference packet they are predicted from has already been decoded. This means that packets are inter dependent and these inter dependencies may be captured for example by a reference tree that describes how levels depend on each other.

In one embodiment, the packets may be fine grained, that is, consisting in small amounts of primitives, and several packets may be independently decodable for example to provide spatial or temporal random access.

### Prediction Module

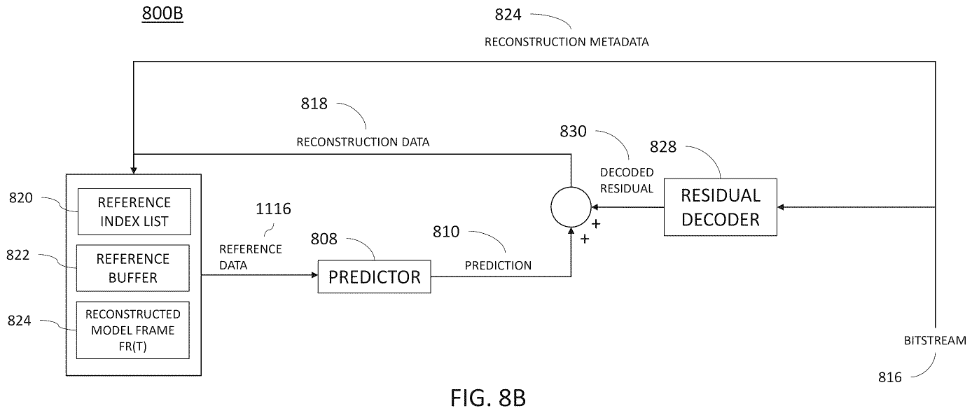

FIGS. 8A and 8B provide flows 800A and 800B illustrating the general way of creating a prediction 810 for an input signal 802, that is by storing previously coded samples called references in a reference buffer 822 and a list of indices 820 that allow to select different reference values in the buffer 822. This can be implemented for example with a codebook where code words are stored in the reference buffer 822 and the indices are stored in the reference index list 820. This can be also implemented by having frames of reference data 824 in the reference buffer 822, while the indices of the reference index list 820 correspond to the frame index. Several other implementations are possible to select and identify groups of references. The encoder process includes receiving 802 an input model frame F(t) that is provided to a prediction search 804. Prediction search 804 processes the input model frame F(t) to extract prediction metadata 806, which is used by predictor 808 to retrieve reference data 826 from reference buffer 822 using reference index list 820. Reference data 826 is used by predictor 808 to generate prediction 810. The reference data 826 enables the construction of the best prediction 810, i.e., the prediction that produces the smallest error measured by a metric such as sum of absolute differences, sum of squared differences etc. The residual signal 812 is obtained by subtracting the prediction from the input signal, encoded by residual encoder 812, and provided as part of the bitstream 816. In some embodiments, bitstream 816 may be decoded by residual decoder 828, resulting in decoded residual 830. Decoded residual 830 may be added to prediction 810, creating reconstruction data 818. Reconstruction data 818 may be stored in reference buffer 822 and added to reference index list 820. Additionally, or alternatively, reconstruction metadata 824 may be extracted from the bitstream and stored in reference buffer 822 and associated with reconstruction data 818.

The encoder may also optimize the prediction such that its cost in bitrate (to encode the prediction information and the residual information) is also taken into account on top of the distortion measurement; this is called rate distortion optimization and can for example be achieved by optimizing the following equation.

$$J = min ( D + λ R ) \qquad ( 1 )$$

Where J is the rate distortion (RD) cost, D is the distortion, R is the bitrate and Xis a Lagrangian multiplier that is for example a function of the chosen quantization parameter to code the residual information. It should be noted that more complex rate distortion optimization strategies can be used, with different metrics and Lagrangian weights.

Additional criteria may impact the best reference selection for the predictor, such as spatial random access possibilities that would constrain the possible choices of references to a given region, or some traversal patterns that allow sequential or parallel coding and decoding for example.

In one embodiment, the encoder codes positional information using references, which can be defined by positions obtained by octree node positions or by input primitive positions. In FIG. 4A, 400A, the reference for a set of primitives in a given portion of the scene (e.g. the region in space described by an octree node) can be chosen with the following criteria:
a) The octree node central position (the reference is not a primitive in this case).
b) The primitive that is the closest to the center of gravity of the primitives of this node. The center of gravity can be obtained by a simple average of the positions of all the primitives in the octree node volume.
c) The center of gravity of the primitives in the octree node volume (the reference is not a primitive in this case).
d) The primitive that is the first on a given traversal pattern of the octree; e.g., the Morton order or Z-scan of the octree, for example to allow for specific read patterns at the decoder side that would be more adapted to hardware architectures despite the potentially larger bitrate for coding residuals.

The coding process requires to first code the references positions and then to code the positions of predicted primitives differentially, for example by coding displacement vectors with 3D cartesian or spherical coordinates.

In one embodiment, the attributes of the primitives that serve as reference for positional coding are encoded as well in a first step to serve as references for attribute prediction as well. In another embodiment, when the positional reference does not correspond to a primitive, reference attributes can be coded using a weighted average of the neighboring (positionally predicted from this reference position) primitives' attributes, or a copy of the nearest neighbor primitive attribute (if the primitive is positionally predicted by this reference), or any other combination from the positionally predicted primitives attributes.

In another embodiment, attribute references may not be associated with a positional reference. That is, the attribute from a primitive that is positionally predicted, may serve as an attribute coding reference. This implies that these primitives attributes that serve as reference need to be coded prior to prediction, for example using a codebook, a neural network, image coding etc. This could also be implemented by coding a virtual primitive whose position corresponds to a primitive P and attributes to a primitive P.

In another embodiment, the reference primitive A used for predicting a primitive P's attribute is different from the reference primitive B used to predict the position of primitive P. In another embodiment, the references for one or more attributes of a primitive correspond to different primitives.

In some embodiments, multiple references for the same attribute data may be used for a given primitive. In one embodiment, the prediction of the position or of an attribute of a primitive uses multiple references and a set of weights. Weights may be chosen based on a simple regular manner (i.e., 1/number of references) or a geometric criterion (e.g. the softmax of the inverse of the distance w.r.t. the predicted point), or based on a blending or interpolation optimization. This is illustrated in FIG. 4C, 400C. Weights, or the strategy used to compute them using already coded information, for example based on positions and distances of the references primitives, may be transmitted per predicted primitive, or in another embodiment by encoding implicit functions that provide blending weights for portions of the scene, e.g. using one or several MLPs.

In some embodiments, multiple references for inter prediction of primitives positions and/or attributes may be used. The following embodiments are illustrated on FIG. 5.

In one embodiment, inter prediction of primitives positions is performed using multiple references that can belong to one or several different temporal frames 502 and 504 than the one of the predicted primitive. In one embodiment, one or more references are located on the same temporal frame t 504 as the predicted primitive 512, while other references (e.g., 506) used for this prediction are located at other temporal frames 502. Multiple reference predictions may use different weights that can be a function of the temporal frame, for example providing stronger weights to a temporal frame that is closer to the one of the primitive, or the other way round. Static backgrounds are an example use case for such predictions. In this case, primitives positions and attributes that correspond to the background can be used for several frames as a reference. When parts of the background get shaded due to clouds or objects moving in front, or due to brightness and illumination changes or due to an object occluding a portion of the background, or an object appearing in the background, then a multi-reference prediction may lower the cost of these changes in terms of the size of residuals.

As an example, the color attribute of a Gaussian splat at time t, with Morton order index m in an octree representation of the scene (other spatial indexing methods are possible such as the position) could be predicted as follows:

$$Prediction ( GS . color [ t ] [ m ] ) = {\sum }_{i = 0}^{K} {w}_{k} ( {t}_{i} , {m}_{i} ) GS . color [ {t}_{i} ] [ {m}_{i} ]$$

$$With {\sum }_{i = 0}^{K} {w}_{k} ( {t}_{i} , {m}_{i} ) = 1$$

Weights can be dependent on time and distance between primitives.

### Coding Causality for Predictions

In order to be able to use primitives positions or attributes as reference, the decoder needs to be able to decode such references before processing predictions. This means that in the bitstream, references should be coded independently from the primitives that will be predicted from such references. This has implications for the decoding process, and for entropy coding or decoding in terms of data independence. Coding the references first can be achieved by mapping primitives used as reference for positions or attributes in a first (reference) packet and primitives being predicted from these references in other packets (or levels) that depend on packet 0. Some primitives may be predicted and then be used as reference for other primitives, this could be called as primary reference, secondary references, etc. In some embodiments, primary references and secondary references are coded together in a specific packet, in which primary references are encoded first and then secondary references after the primary references. One can represent such reference hierarchies with a reference tree at the encoder side and make sure no child is coded before a parent in the target packet. In another embodiment, primary and secondary references are encoded in different packets, or more generally, parents are coded in a coarser packet/level than the children.

In another embodiment, temporal references of a frame t are encoded once all packets of previous frames are encoded. In another embodiment, packets corresponding to a low level may be coded for several temporal frames before the packets bringing additional details for the first frame are encoded. This is a choice of buffer size and latency, as well as access granularity.

In another embodiment, primary references are encoded in a separate packet for the whole sequence with per-frame random access.

In another embodiment the primitives are decoded sequentially (for example following their Morton order). In that case the primitives don't necessarily have to be divided in packets and as primitives are decoded they can be used as a predictors for the following ones and the buffer might contain the last K decoded primitives. In another embodiment instead of placing the last K decoded primitives in the buffers, if some of the attributes of the currently considered primitive have already been decoded, then the buffer could be filled with the previously decoded primitives based on a similarity with the currently considered one (e.g. closeness in space/time, similarity in geometric attributes, etc . . . ).

### Decoder

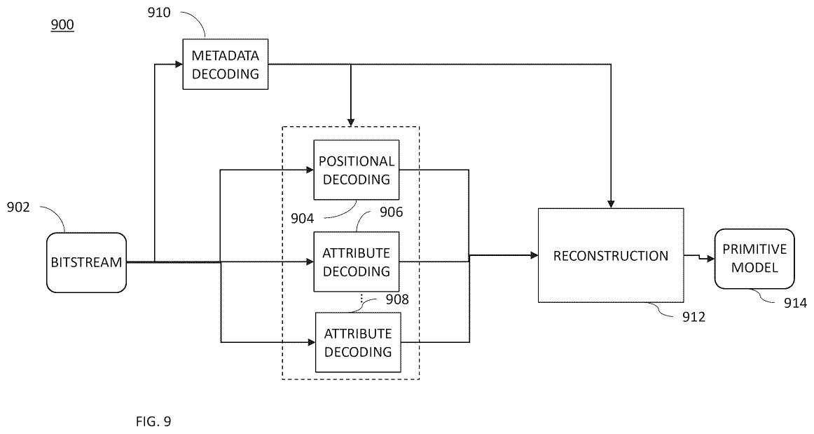

FIG. 9 illustrates and example flowchart 900 of a decoder operations in accordance with one or more embodiments of the disclosed technology. The decoder may be symmetric to the encoder as it receives a bitstream 902 as input, decodes and extracts 910 metadata information from the bitstream, decodes positional 904 and attributes 906/908 data, and reconstructs 912 primitives 914 using the decoded data and the extracted metadata. The decoder predictions and codecs may be the same as the ones used in the encoder. The decoder extracts the reference information from the metadata to initialize its prediction process modules and reference buffers. It extracts the reference tree to determine the number of reference packets (levels) that are required to decode the content at a given density and for a number of frames (see signaling Section).

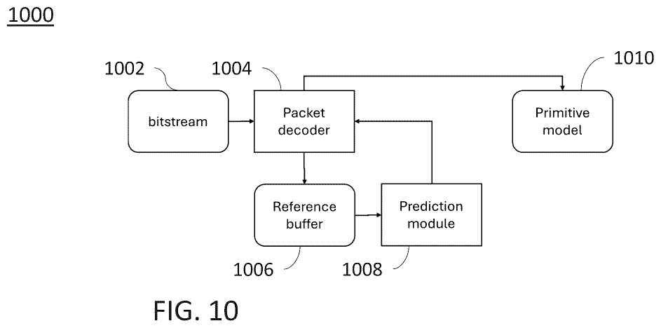

FIG. 10 illustrates an example workflow 1000 of decoding with one or more reference mechanisms. In this example, the decoder receives a bitstream 1002 as input and decodes positional and attribute data 1004 which is used to reconstruct primitive model 1010. Additionally, or alternatively, packet decoder 1004 may retrieve previously decoded primitives from reference buffer 1006 via prediction module 1008, as described herein.

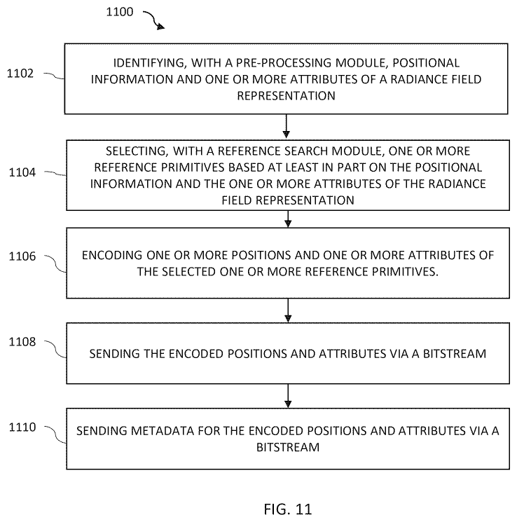

FIG. 11 illustrates an example workflow 1100 of creating predictor output. The predictor output, called prediction may be performed at the decoder, and generates the same value as in the encoder (see FIG. 8), given that the references used at encoder and decoder are the same. This is achieved by typically using decoded and reconstructed samples as references instead of using original input samples at the encoder side.

The predictor output, called prediction is also performed at the decoder, and generates the same value as in the encoder, given that the references used at encoder and decoder are the same. This is achieved by typically using decoded and reconstructed samples as references instead of using original input samples at the encoder side.

### Signaling Examples

Table A lists primitive types that are encoded in the bitstream. Table B lists attribute types that are encoded for the primitives in the bitstream.

TABLE A
Primitive Type

| primitive_type Index | Primitive type |
|---|---|
| 0 | 3D Gaussian Splat |
| 1 | 2D Gaussian Splat |
| 2 | Ellipsoids |
| 3 | Spheres |
| 4 | Billboards/Planes |
| 5 | Convex shapes |
| 6 | Generalized Gaussians |
| 7..15 | RESERVED |

The type of attributes must be signaled for the primitive as detailed in Table B

TABLE B
Attribute types

| Attribute | | |
|---|---|---|
| types index | Identifier | Attribute type |
| 0 | ATTR_POSITION | Position |
| 1 | ATTR_ROTATION | Rotation |
| 2 | ATTR_SCALE | Scale |
| 3 | ATTR_BOX | Box |
| 4 | ATTR_RADIUS | Radius |
| 5 | ATTR_COLOR | Color |
| 6 | ATTR_OPACITY | Opacity |
| 7 | ATTR_SPHERICAL_HARMONICS_BAND_1 | Spherical Harmonics Band 1 |
| 8 | ATTR_SPHERICAL_HARMONICS_BAND_2 | Spherical Harmonics Band 2 |
| 9 | ATTR_SPHERICAL_HARMONICS_BAND_3 | Spherical Harmonics Band 3 |
| 10..14 | ATTR_RESERVED | Reserved |
| 15 | ATTR_UNSPECIFIED | Unspecified |

The list of reference mechanism is listed in Table C. Reference mechanisms are as follows.

NONE indicates that no referencing is used, i.e., no prediction is based on primitives positions or attributes as references.

POSITION_MONO indicates that a single reference can be used for predicting primitive positions, per primitive.

POSITION_MULTI indicates that multiple references can be used in the bitstream for prediction positions of primitives, per primitive.

ATTRIBUTE_MONO indicates that a single reference primitive can be used to predict the attribute of another primitive in the bistream, per primitive.

ATTRIBUTE_MULTI indicates that multiple reference primitives can be used to predict the attribute of another primitive in the bistream, per primitive.

TEMPORAL_MONO indicates that a single reference primitive can be used to predict the attribute or the position of another primitive in another frame in the bistream, per primitive.

ATTRIBUTE_MULTI indicates that multiple reference primitives can be used to predict the attribute or position of another primitive in another frame in the bistream, per primitive.

ATTRIBUTE_HYBRID indicates that multiple reference can be used to predict the attribute or position of another primitive in the same or another frame in the bistream, per primitive.

TABLE C
List of reference mechanisms

| Multi-referencing | Multi-referencing |
|---|---|
| mechanisms index | mechanisms |
| 0 | NONE |
| 1 | POSITIONAL_MONO |
| 2 | POSITIONAL_MULTI |
| 3 | ATTRIBUTE_MONO |
| 4 | ATTRIBUTE_MULTI |
| 5 | TEMPORAL_MONO |
| 6 | TEMPORAL_MULTI |
| 7 | TEMPORAL_HYBRID |
| 8..15 | RESERVED |

TABLE D
metadata describing reference tree structure

| | |
|---|---|
| reference_tree( ) | |
| maximum_depth_minus1 | ue(v) |
| tree_edges_count minus1 | ue(v) |
| for( i = 0; i < tree_edges_count_minus1 + 1; i++) { | |
| parent_index [i] | ue(v) |
| child_index[i] | ue(v) |
| } | |
| } | |

maximum_depth_minus1 plus 1 indicates the depth of the reference tree. This can be used to determine the number of Level-of-Details in the sequence or frame.

tree_edges_count_minus1: plus 1 indicates the number of edges of the reference tree. Edges are encoded as (parent_index, child_index) pairs.

parent_index[i]: indicates the index in the tree of the parent node in the edge number i of the tree.

child_index[i]: indicates the index in the tree of the child node in the edge number i of the tree.

The reference tree may be signaled in or along the bitstream, for example in an sequence parameter set, a frame parameter set, or a Supplemental Enhancement Information message (SEI) etc.

Table E describes packets/levels gathering references of the same type together as “reference packets” in analogy to what is sometimes called entropy packets, i.e., a portion of data that can be decoded independently provided that its dependencies were decoded beforehand. This information can be signalled in or along the bistream into parameter sets or in a SEI message.

TABLE E
Reference packet map

| | |
|---|---|
| Reference_packet_map ( ) | |
| Reference_packet_count_minus1 | ue(v) |
| for (i =0; i < reference_packet_count_minus1 + 1; i++){ | |
| Packet_to_node_map[i] | ue(v) |
| Packet_frame_count_minus 1 [i] | ue(v) |
| for (j=0; j< Packet_frame_count_minus1[i] + 1; j++){ | |
| frame_index [i][j] | ue(v) |
| } | |
| } | |
| } | |

Reference_packet_count_minus1 plus 1 indicates the number of reference packets in the bitstream.

Packet_to_node_map[i] indicates the node of the reference tree this packet corresponds to.

Packet_frame_count_minus1[i] plus 1 indicates the number of temporal frames the packet is linked to in the bitstream.

frame_index[i][j] indicates the j^{th} frame index of reference packet number i.

### ADDITIONAL CONSIDERATIONS

The following examples are provided and described herein.

In accordance with one aspect, an example apparatus is provided comprising: at least one processor; and at least one memory storing instructions that, when executed with the at least one processor, cause the apparatus to perform: identifying, with a pre-processing module, positional information and one or more attributes of a radiance field representation. Additionally, the apparatus may be caused to perform: selecting, with a reference search module, one or more reference primitives based at least in part on the positional information and the one or more attributes of the radiance field representation. Additionally, the apparatus may be caused to perform: encoding one or more positions and one or more attributes of the selected one or more reference primitives.

In accordance with the example embodiment, the radiance field representation may be one of a 3D Gaussian Splat, a spherical point cloud with spherical harmonics, a 2D Gaussian Splat, a Billboard, or an Ellipsoid. Further, the one or more reference primitives may be characterized by a position in a N-dimensional space. Additionally, or alternatively, the one or more attributes of the radiance field representation may include one or more of scales, rotations, dimensions, color, representation learned through gradient descent or a neural network, semantic information, and material information. Further, the apparatus may include a positional coding module and one or more attribute coding modules configured to predict positional data and attribute data of the radiance field representation, respectively. In some embodiments, the positional data and the attribute data of the radiance field representation may be predicted using voxelization and quantization. Further, the position coding module may include a point cloud codec using octree-based coding techniques, one or more projection-based coding techniques, or both. In some cases, the one or more attribute coding modules may include a dedicated attribute codec, neural approach, projections to video, vector quantization, or a combination thereof. In some embodiments, the computer program code may be further configured to, with the at least one processor, cause the apparatus at least to perform: weighting of one or more positions of the selected reference primitives, wherein at least one of the one or more positions of the selected one or more reference primitives may be used to predict the position of the radiance field representation, and wherein at least one of the one or more attributes of the selected one or more reference primitives may be used to predict one or more attributes of the radiance field representation.

Turning to FIG. 11, in accordance with at least one embodiment, an example method 1100 is provided including identifying 1102, with a pre-processing module, positional information and one or more attributes of a radiance field representation; selecting 1104, with a reference search module, one or more reference primitives based at least in part on the positional information and the one or more attributes of the radiance field representation; and encoding 1106 one or more positions and one or more attributes of the selected one or more reference primitives. Additionally, method 1100 is provided including sending 1108 the encoded positions and attributes via a bitstream; and sending 1110 metadata for the encoded positions and attributes via a bitstream.

In accordance with one aspect, an example apparatus is provided comprising: at least one processor; and at least one memory storing instructions that, when executed with the at least one processor, cause the apparatus to perform: decoding one or more bitstreams to extract metadata information, positional information for a radiance field representation, and one or more attributes of the radiance field representation. Additionally, the apparatus may be caused to perform: reconstructing, based at least in part on the extracted metadata information, the radiance field representation for volumetric rendering using one or more reference primitives obtained from a plurality of reference primitives.

In accordance with the example embodiment, the instructions, when executed, may further cause the apparatus to perform: initializing one or more prediction process modules and one or more reference buffers using reference information extracted from metadata information. In some cases, the apparatus may be caused to perform: determining, with a reference tree, a number of reference packets required to decode content of the one or more bitstreams at a given density and for a number of frames.

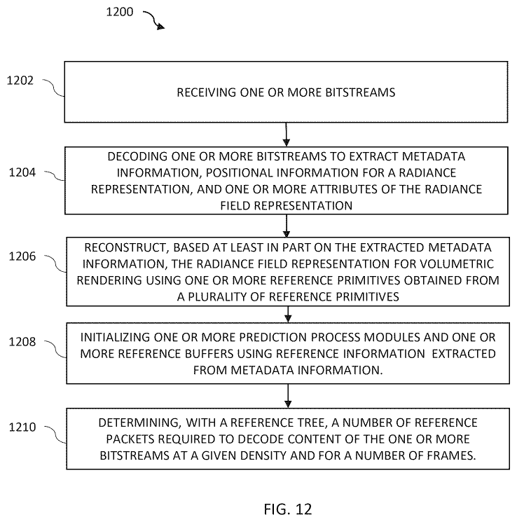

Turning to FIG. 12, in accordance with at least one embodiment, an example method 1200 is provided including receiving 1202 one or more bitstreams; decoding 1204 one or more bitstreams to extract metadata information, positional information for a radiance field representation, and one or more attributes of the radiance field representation; and reconstructing 1206, based at least in part on the extracted metadata information, the radiance field representation for volumetric rendering using one or more reference primitives obtained from a plurality of reference primitives. Method 1200 further includes initializing 1208 one or more prediction process modules and one or more reference buffers using reference information extracted from metadata information; and determining 1210, with a reference tree, a number of reference packets required to decode content of the one or more bitstreams at a given density and for a number of frames.

The term “non-transitory,” as used herein, is a limitation of the medium itself (i.e., tangible, not a signal) as opposed to a limitation on data storage persistency (e.g., RAM vs. ROM).

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (iii) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

1. An apparatus comprising:
at least one processor; and
at least one memory including computer program code, the at least one memory and the computer program code configured to, with the at least one processor, cause the apparatus at least to perform:
identifying, with a pre-processing module, positional information and one or more attributes of a radiance field representation;
selecting, with a reference search module, one or more reference primitives based at least in part on the positional information and the one or more attributes of the radiance field representation; and
encoding one or more positions and one or more attributes of the selected one or more reference primitives.

2. The apparatus of claim 1, wherein the radiance field representation is one of a 3D Gaussian Splat, a spherical point cloud with spherical harmonics, a 2D Gaussian Splat, a Billboard, or an Ellipsoid.

3. The apparatus of claim 1, wherein the one or more reference primitives are characterized by a position in a N-dimensional space.

4. The apparatus of claim 1, wherein the one or more attributes of the radiance field representation include one or more of scales, rotations, dimensions, color, representation learned through gradient descent or a neural network, semantic information, and material information.

5. The apparatus of claim 1, wherein the apparatus includes a positional coding module and one or more attribute coding modules configured to predict positional data and attribute data of the radiance field representation, respectively.

6. The apparatus of claim 5, wherein the positional data and the attribute data of the radiance field representation are predicted using voxelization and quantization.

7. The apparatus of claim 5, wherein the position coding module includes a point cloud codec using octree-based coding techniques, one or more projection-based coding techniques, or both.

8. The apparatus of claim 5, wherein the one or more attribute coding modules include a dedicated attribute codec, neural approach, projections to video, vector quantization, or a combination thereof.

9. The apparatus of claim 1, wherein the computer program code is further configured to, with the at least one processor, cause the apparatus at least to perform:
weighting of one or more positions of the selected reference primitives,
wherein at least one of the one or more positions of the selected one or more reference primitives is used to predict the position of the radiance field representation, and
wherein at least one of the one or more attributes of the selected one or more reference primitives is used to predict one or more attributes of the radiance field representation.

10. An apparatus comprising:
at least one processor; and
at least one memory including computer program code, the at least one memory and the computer program code configured to, with the at least one processor, cause the apparatus at least to perform:
decoding one or more bitstreams to extract metadata information, positional information for a radiance field representation, and one or more attributes of the radiance field representation; and
reconstructing, based at least in part on the extracted metadata information, the radiance field representation for volumetric rendering using one or more reference primitives obtained from a plurality of reference primitives.

11. The apparatus of claim 10, wherein the computer program code is further configured to, with the at least one processor, cause the apparatus at least to perform:
initializing one or more prediction process modules and one or more reference buffers using reference information extracted from metadata information.

12. The apparatus of claim 10, wherein the computer program code is further configured to, with the at least one processor, cause the apparatus at least to perform:
determining, with a reference tree, a number of reference packets required to decode content of the one or more bitstreams at a given density and for a number of frames.

13. The apparatus of claim 10, wherein the radiance field representation is one of a 3D Gaussian Splat, a spherical point cloud with spherical harmonics, a 2D Gaussian Splat, a Billboard, or an Ellipsoid.

14. The apparatus of claim 10, wherein the one or more attributes of the radiance field representation include one or more of scales, rotations, dimensions, color, representation learned through gradient descent or a neural network, semantic information, and material information.

15. A method comprising:
decoding one or more bitstreams to extract metadata information, positional information for a radiance field representation, and one or more attributes of the radiance field representation; and
reconstructing, based at least in part on the extracted metadata information, the radiance field representation for volumetric rendering using one or more reference primitives obtained from a plurality of reference primitives.

16. The method of claim 15, further comprising:
initializing one or more prediction process modules and one or more reference buffers using reference information extracted from metadata information.

17. The method of claim 15, further comprising:
determining, with a reference tree, a number of reference packets required to decode content of the one or more bitstreams at a given density and for a number of frames.

18. The method of claim 15, wherein the radiance field representation is one of a 3D Gaussian Splat, a spherical point cloud with spherical harmonics, a 2D Gaussian Splat, a Billboard, or an Ellipsoid.

19. The method of claim 15, wherein the one or more reference primitives are characterized by a position in a N-dimensional space.

20. The method of claim 15, wherein the one or more attributes of the radiance field representation include one or more of scales, rotations, dimensions, color, representation learned through gradient descent or a neural network, semantic information, and material information.
